(19) United States
(12) Patent Application Publication
(10) Pub. No.: US 2009/0320237 A1
(43) Pub. Date: Dec. 31, 2009

(54) DOORSTOP ASSEMBLY

(76) Inventor: Kerry Patrick Kersting, Gilbert, AZ (US)

Correspondence Address: WEISS & MOY PC, 4204 NORTH BROWN AVENUE, SCOTTSDALE, AZ, 85251, US

(21) Appl. No.: 12/428,377

(22) Filed: Apr. 22, 2009

Related U.S. Application Data
(60) Provisional application No. 61/075,432, filed on Jun. 25, 2008.

(51) Int. Cl. E05F 5/00

(52) U.S. Cl. 16/82

(57) ABSTRACT

A doorstop assembly having a spring action clamping bracket to affix the assembly to a wall baseboard or door is disclosed. The assembly prevents the need to bore holes into either the wall baseboard or the door. The doorstop assembly also accommodates for varying widths of doors or baseboards.

### CROSS-REFERENCE TO RELATED APPLICATION

This application claims priority to a corresponding provisional application U.S. Ser. No. 61/075,432 filed Jun. 25, 2008 in the name of the Applicant.

### FIELD OF THE INVENTION

The invention relates generally to doorstops, and more specifically to doorstop having a spring action clamping mechanism to affix the doorstop to a wall baseboard or door.

### BACKGROUND OF THE INVENTION

Traditional doorstops typically have a threaded end that is screwed directly into a wall baseboard. Those types of doorstops inevitably damage the wall baseboard when they become loose and strip out of their threaded holes. This often happens when they are kicked or run into by a vacuum cleaner, or from continuous use of stopping the door. Once the doorstop has come out of the wall baseboard, they must be refastened, thus requiring the repair of the damaged, stripped hole and the boring of a new in the wall baseboard. Oftentimes, no one is aware that the doorstop has become separated or misaligned from the wall baseboard. When this happens, a door may slam into the wall, causing severe wall damage from the door knob.

The present invention is directed to a doorstop assembly having a spring action clamping bracket to affix the doorstop assembly to a wall baseboard or door without having to bore holes into either the wall baseboard or the door.

### SUMMARY OF THE INVENTION

In accordance with one embodiment of the present invention, a doorstop assembly is disclosed. The doorstop assembly comprises a U-shaped bracket and a doorstop coupled to one side of the bracket.

In accordance with another embodiment of the present invention, a doorstop assembly to be coupled to a door is disclosed. The doorstop assembly comprises a flexible U-shaped bracket having a first side that lays flat along a side of the door, a second side that lays flat along an edge of the door, and a third side that lays flat along an opposite side of the door. The doorstop assembly also has a doorstop having a base, a shaft, and a bumper, wherein the base of the doorstop is coupled perpendicularly to the first side of the bracket.

In accordance with another embodiment of the present invention, a doorstop assembly to be coupled between a baseboard and a wall is disclosed. The doorstop assembly comprises a flexible U-shaped bracket having a first side, a second side, and, a third side that lays flat along the wall and behind the baseboard. The doorstop assembly also has a doorstop having a base, a shaft, and a bumper, wherein the base of the doorstop is coupled perpendicularly to the first side of the bracket.

The foregoing and other objects, features, and advantages of the invention will be apparent from the following, more particular description of the preferred embodiments of the invention, as illustrated in the accompanying drawings.

### BRIEF DESCRIPTION OF THE DRAWINGS

FIG. 1 is an elevated perspective view of a bracket of a doorstop of the present invention, shown with a threaded stud.

FIG. 2 is an elevated perspective view of another embodiment of a bracket of the doorstop of the present invention, shown with a threaded stud.

FIG. 3 is an elevated perspective view of another embodiment of a bracket of the doorstop of the present invention, shown with a threaded bracket extrusion.

FIG. 4 is an elevated perspective view of another embodiment of a bracket of the doorstop of the present invention, shown with a threaded bracket extrusion.

FIG. 5 is an exploded elevated perspective view of the doorstop of the present invention, shown with the bracket of FIG. 1.

FIG. 6 is an exploded side view of the doorstop of the present invention, shown with the bracket of FIG. 4 and shown affixed to a wall baseboard.

FIG. 7 is an exploded side view of the doorstop of the present invention, shown with the bracket of FIG. 2 and shown affixed to the bottom edge of a door.

FIG. 8 is a side view of a doorstop of the present invention, shown with another embodiment of a bracket having a take-up bend, and shown affixed to the bottom edge of a door. The doorstop bumper of the doorstop is shown stopped against the wall baseboard.

FIG. 9 is a side view of the doorstop of FIG. 6. The door is shown stopped against the doorstop bumper.

FIG. 10 is an elevated perspective view of the bracket of the doorstop of FIG. 8, shown with a take-up bend and a threaded stud.

FIG. 11 is an elevated perspective view of another embodiment of a bracket of the doorstop of the present invention, shown with a take-up bend and a threaded bracket extrusion.

### DETAILED DESCRIPTION OF THE PREFERRED EMBODIMENTS

The novel features believed characteristic of the invention are set forth in the appended claims. The invention will best be understood by reference to the following detailed description of illustrated embodiments when read in conjunction with the accompanying drawings, wherein like reference numerals and symbols represent like elements.

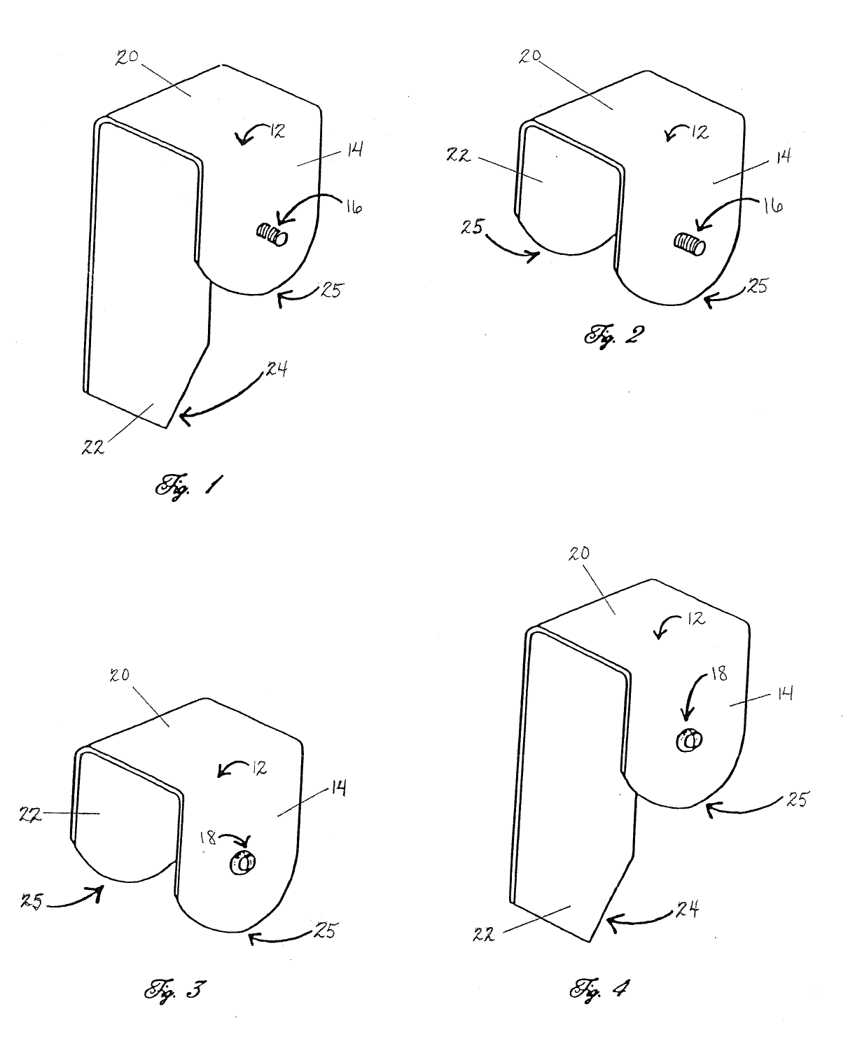

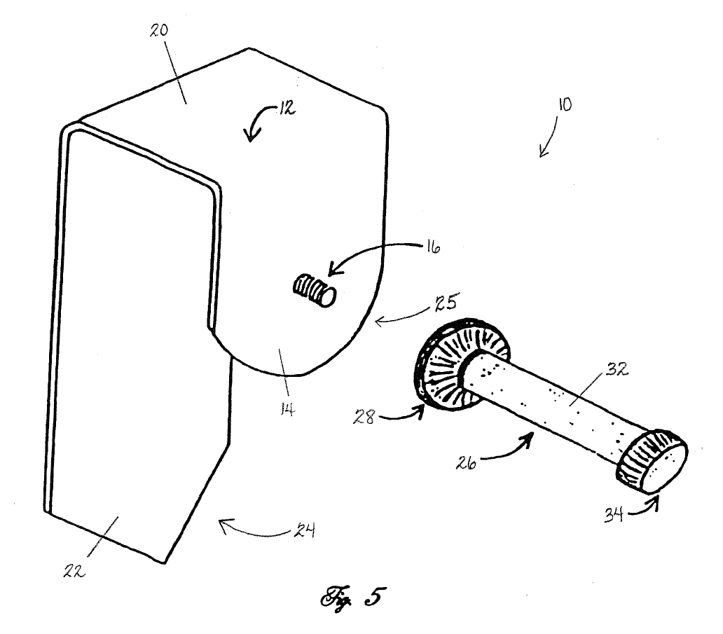

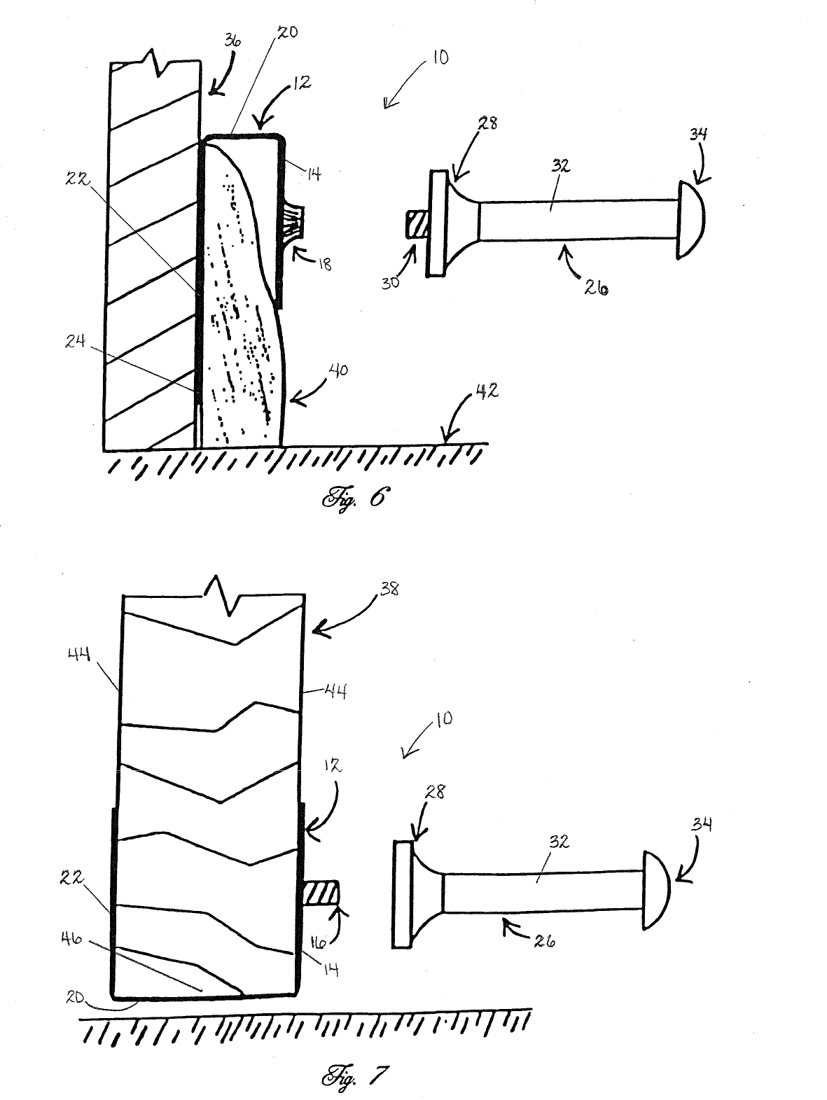

FIGS. 1-11 together show a doorstop assembly, hereinafter doorstop assembly 10. The doorstop assembly 10 comprises a bracket 12 and a doorstop 12.

Referring to FIGS. 1-4, the doorstop assembly 10 has a U-shaped bracket 12. The bracket 12 may be made of spring steel or other metal, plastic, or some other flexible material. The flexibility of the bracket 12 causes a spring clamping action that allows it to be mounted to a door 38 or to a wall baseboard 40. There are no screws or studs in the doorstop assembly 10 that would have to penetrate the baseboard 40 or the door 38.

Where no baseboard 40 is present, the bracket 12 may be mounted anywhere along the edge 46 of the door 38. Keeping the doorstop 26 at the outer edge of the door instead of around the hinge area, provides a better mechanical stopping means and will not cause unwanted damage to the hinge and door jam area. Trying to stop the door from the inner most area around the hinges takes much more energy and eventually causes undo wear and damage to the hinge, door jam, and door 38. Furthermore, a typical doorstop usually cannot be mounted to whatever the door 38 is stopping against; i.e. refrigerator, bathtub, etc. In these instances, the invention can be easily mounted on the edge of the door 38 allowing the door 38 to safely come to rest against the object preventing any damage to the door 38 and/or object.

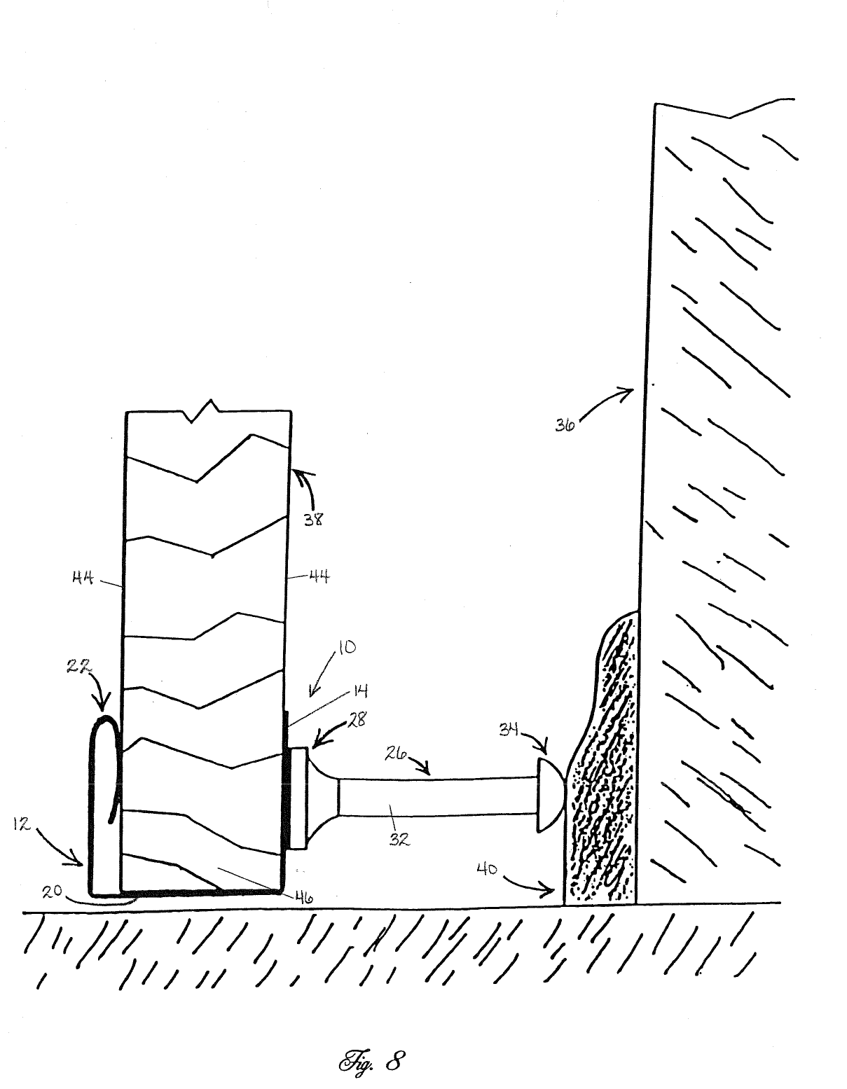

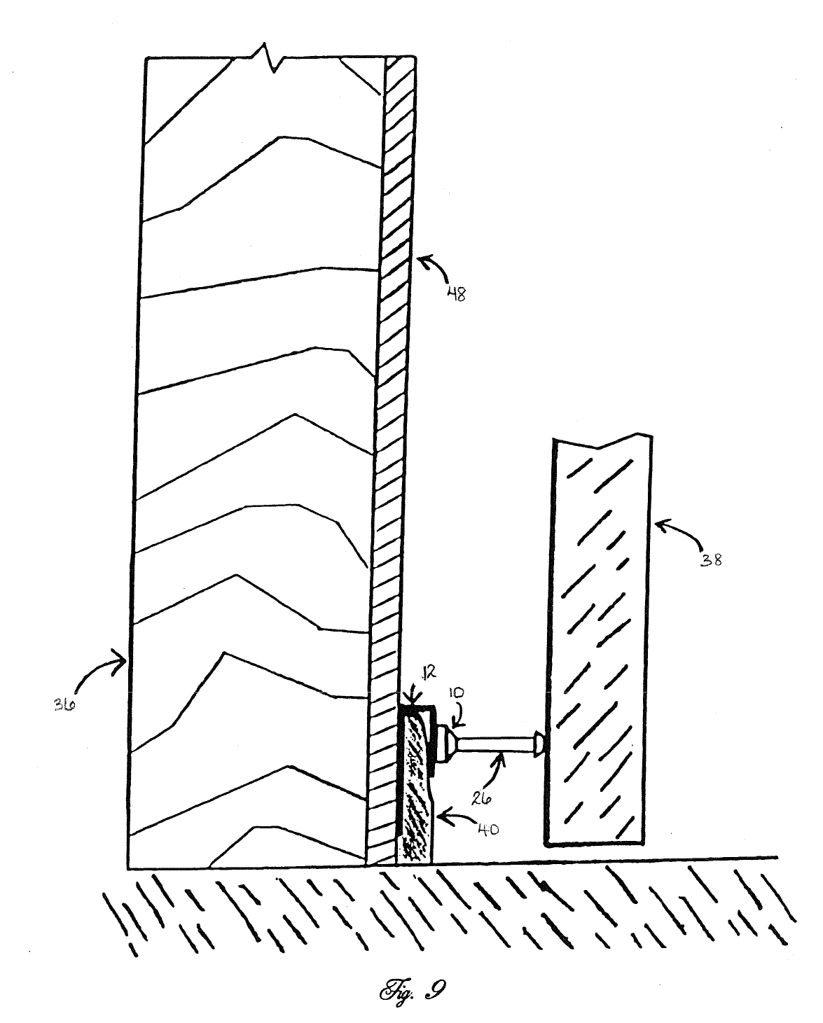

The bracket 12 may be U-shaped, having a first side 14, a second side 20, and a third side 22. As shown in the figures, a right angle may be formed where the first side 14 and the second side 20 meet and another right angle may be formed where the second side 20 and the third side 22 meet. Where the doorstop assembly 10 is coupled to a door 38 (see FIGS. 7 and 8), the first side 14 of the bracket 12 lays flat along a side 44 of the door 38, the second side 20 of the bracket 12 lays flat along an edge 46 of the door 38, and the third side 22 of the bracket 12 lays flat along the opposite side 44 of the door 38. Where the doorstop assembly 10 is coupled to a baseboard 40 (see FIGS. 6 and 9), the first side 14 of the bracket 12 contacts the front of the baseboard 40, the second side 20 of the bracket 12 contacts the top of the baseboard 40, and the third side 22 of the bracket 12 is inserted in between the wall 36 and the back of the baseboard 40.

The first side 14 and/or the third side 22 of the bracket 12 may have a curved end 25. These curved ends 25 may help to prevent items, such as the clothing from a person walking by or a cleaning cloth used to wipe the baseboard 40 or floor 42, from being caught on what would otherwise be pointed edges of the sides 14/22 of the bracket 12. The curved ends 25 also provide for easier installation.

Referring to FIGS. 5-9, the doorstop 26 is coupled perpendicularly to the first side 14 of the bracket 12. The doorstop 26 has a base 28, a shaft 32, and a bumper 34. The shaft 32 may be made of any suitable solid material or made or a flexible material, such as a spring. And the bumper 34 may be made of a resilient material, such as rubber, to prevent damage to the door 38.

The first side 14 of the bracket 12 may have a threaded stud 16 (see FIGS. 1, 2, 5, and 7) that may be screwed into a corresponding threaded hole in the base 28 of the doorstop 26. Or, the base 28 may have a threaded stud 30 that may be screwed into a corresponding threaded hole 18 in the first side 14 of the bracket 12 (see FIGS. 3, 4, and 6). Substantial benefit may also be derived from the doorstop 26 being integral to the bracket 12 or from the doorstop 26 being coupled by some other suitable means to the bracket 12.

The width of the second side 20 of the bracket 12, i.e. the distance between the first side 14 of the bracket 12 and the third side 22 of the bracket 12, may vary. This will help to accommodate for the varying thicknesses of the doors 38 and baseboards 40 that the brackets 12 are coupled to.

The third side 22 of the bracket 12 may have a pointed end 24 (see FIGS. 1, 4, 5, 6, and 9). Oftentimes, there is drywall, caulking, paint, or another type filler material 48 between the wall 36 and the baseboard 40 (shown in FIG. 9). A pointed end 24 would be beneficial for penetrating this filler material 48 when inserting the third side 22 of the bracket 12 between the wall 36 and the baseboard 40.

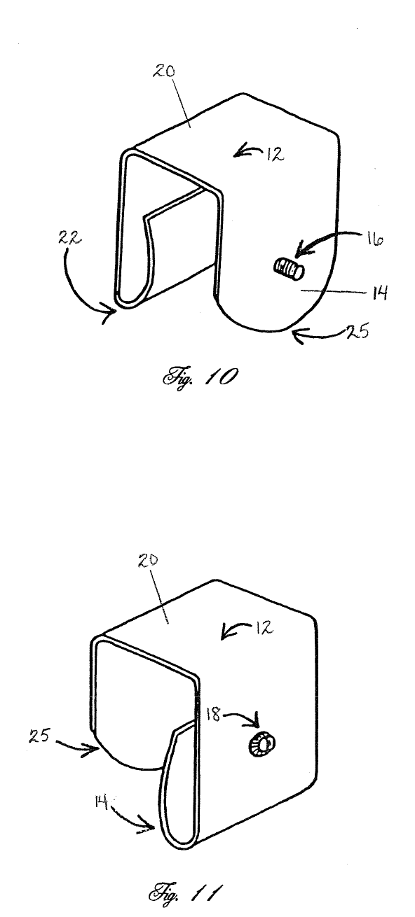

Referring to FIGS. 10 and 11, the first side 14 (see FIG. 11) or the third side 22 (see FIG. 10) of the bracket 12 may be curved inwardly upon itself. The distance between the inside surface of the first side 14 of the bracket 12 and the inwardly curved third side 22 of the bracket 12 (or between the inside surface of the third side 22 of the bracket 12 and the inwardly curved first side 14 of the bracket 12) may vary to allow for the varying thickness of the doors 38 that the brackets 12 are coupled to. The first side 14 (or third side 22) is curved inwardly in such a manner as to provide a clamp-like action enabling the bracket 12 to fit snugly on doors 38 or baseboards 40. It should be clearly understood that substantial benefit may also be derived from both the first side 14 and the third side 22 of the bracket 12 being curved inwardly upon them when the bracket 12 is coupled to a door 38. Where the bracket 12 is coupled to a baseboard 40, only the first side 14 of the bracket 12 may be curved inwardly upon itself.

While the invention has been particularly shown and described with reference to preferred embodiments thereof, it will be understood by those skilled in the art that the foregoing and other changes in form and details may be made therein without departing from the spirit and scope of the invention.

I claim:

1. A doorstop assembly comprising:
a U-shaped bracket; and
a doorstop coupled to one side of the bracket.

2. The doorstop assembly of claim 1 wherein one side of the bracket has a pointed end for penetrating filler material between drywall and a baseboard.

3. The doorstop assembly of claim 1 wherein at least one side of the bracket is curved inwardly upon itself.

4. The doorstop assembly of claim 1 wherein one side of the bracket has a threaded stud to couple with a base of the doorstop.

5. The doorstop assembly of claim 1 wherein one side of the bracket has a threaded hole to couple with a base of the doorstop.

6. The doorstop assembly of claim 1 wherein at least one side of the bracket has a curved end.

7. A doorstop assembly to be coupled to a door comprising:
a flexible U-shaped bracket having:
a first side that lays flat along a side of the door;
a second side that lays flat along an edge of the door; and
a third side that lays flat along an opposite side of the door;
a doorstop having:
a base;
a shaft; and
a bumper;
wherein the base of the doorstop is coupled perpendicularly to the first side of the bracket.

8. The doorstop assembly of claim 7 further comprising a threaded stud protruding from the first side of the bracket for being screwed into the base of the doorstop.

9. The doorstop assembly of claim 7 further comprising:
a threaded stud protruding from the base of the doorstop; and
a threaded hole in the first side of the bracket to receive the threaded stud of the doorstop.

10. The doorstop assembly of claim 7 wherein the first side of the bracket is curved inwardly upon itself.

11. The doorstop assembly of claim 7 wherein the third side of the bracket is curved inwardly upon itself.

12. The doorstop assembly of claim 7 wherein at least one of the first side and the third side have curved ends.

13. A doorstop assembly to be coupled between a baseboard and a wall comprising:
a flexible U-shaped bracket having:
a first side;
a second side; and
a third side that is inserted between the wall and the baseboard;
a doorstop having:
a base;
a shaft; and
a bumper;
wherein the base of the doorstop is coupled perpendicularly to the first side of the bracket.

14. The doorstop assembly of claim 13 wherein the third side of the bracket has a pointed end for penetrating filler material between the baseboard and the wall.

15. The doorstop assembly of claim 14 wherein the first side of the bracket has a curved end.

16. The doorstop assembly of claim 13 wherein at least one of the first side and the third side has a curved end.

17. The doorstop assembly of claim 13 further comprising a threaded stud protruding from the first side of the bracket for being screwed into the base of the doorstop.

18. The doorstop assembly of claim 13 further comprising:
a threaded stud protruding from the base of the doorstop; and
a threaded hole in the first side of the bracket to receive the threaded stud of the doorstop.

19. The doorstop assembly of claim 13 wherein the first side of the bracket is curved inwardly upon itself.
